(19) United States
(12) Patent Application Publication
(10) Pub. No.: US 2010/0259200 A1
(43) Pub. Date: Oct. 14, 2010

(54) LED LIGHTING DEVICE

(76) Inventor: David M. Beausoleil, Ridgewood, NJ (US)

Correspondence Address: Catalina & Associates;A Professional Corporation, 1319 Park Street, Suite 100, Robbinsville, NJ, 08691, US

(21) Appl. No.: 12/607,416

(22) Filed: Jan. 13, 2010

Related U.S. Application Data
(60) Provisional application No. 61/169,191, filed on Apr. 14, 2009.

(51) Int. Cl. H05B 37/00; H05B 39/00

(52) U.S. Cl. 315/320; 315/313

(57) ABSTRACT

The present invention relates to LED lighting devices and, more particularly, to an LED lighting device which luminous intensity may be regulated by a user of the device. In one embodiment, the LED lighting device includes a user-operated switching controller, which is adapted for selectively energizing a pre-determined portion of LED arrays of the device. The LED lighting device may also include a user-controlled means of modifying beam angle spread of the emitted light.

### CROSS REFERENCE TO RELATED APPLICATIONS

This application is related to and claims benefit from pending provisional U.S. patent application Ser. No. 61169191, filed Apr. 14, 2009, which is incorporated herein by reference in its entirety.

### FIELD OF THE INVENTION

The present invention relates generally to LED lighting devices and, more specifically, to LED lighting devices with user-controlled light intensity and user-controlled means of modifying beam angle spread.

### BACKGROUND OF THE INVENTION

In the recent years, various configurations of light emitting diode (LED) lighting devices for indoor and outdoor applications have been developed. In comparison with conventional incandescent lighting devices, LED lighting devices have low power consumption, long service life, and high response speed. However, in-situ control of light intensity of LED lighting devices and selecting a desired beam angle spread still represent a challenging task.

### SUMMARY OF THE INVENTION

An LED lighting device with user-controlled light intensity is disclosed. In one embodiment, the LED lighting device comprises a plurality of arrays of LEDs, a power module adapted for energizing the arrays, and a user-operated switching controller. Each such array may include one or more LEDs. The switching controller is configured to regulate intensity of the light emitted by the LED lighting device by selectively coupling or decoupling the pre-determined arrays to/from the power module. In further embodiments, beam angle spread of the emitted light may also be controlled by a user of the LED lighting device. In particular, beam-forming optics of the LED lighting device can be interchanged by the user, thereby modifying the beam angle spread (i.e., angle of the cone of the emitted light), for example, from about 12° to 24°, 36°, or 60°.

All objects, features and advantages of the present invention will become apparent in the following detailed written description and appended drawings. It has been contemplated that features of one embodiment of the invention may be incorporated in other embodiments thereof without further recitation.

The Summary is neither intended nor should it be construed as being representative of the full extent and scope of the present invention, which these and additional aspects will become more readily apparent from the detailed description, particularly when taken together with the appended drawings.

### BRIEF DESCRIPTION OF THE DRAWINGS

FIG. 1 is a schematic diagram of an LED lighting device with user-controlled light intensity, according to one embodiment of the invention.

FIG. 2 is a schematic drawing illustrating an exemplary LED lighting device, according to one embodiment of the invention.

The images in the drawings are simplified for illustrative purposes and are not depicted to scale.

To facilitate understanding, identical reference numerals are used in the drawings to designate, where possible, substantially identical elements that are common to the figures, except that alphanumerical extensions and/or suffixes may be added, when appropriate, to differentiate such elements.

### DETAILED DESCRIPTION

The present invention provides an LED lighting device with user-controlled light intensity and user-controlled beam angle spread. The invention may advantageously be utilized as an energy-efficient source of spot illumination of indoor and outdoor spaces. Particularly, the invention may be used in landscape lighting applications for illuminating, for example, specimen trees, gardens, houses, statuary, architectural details and the like objects and structures.

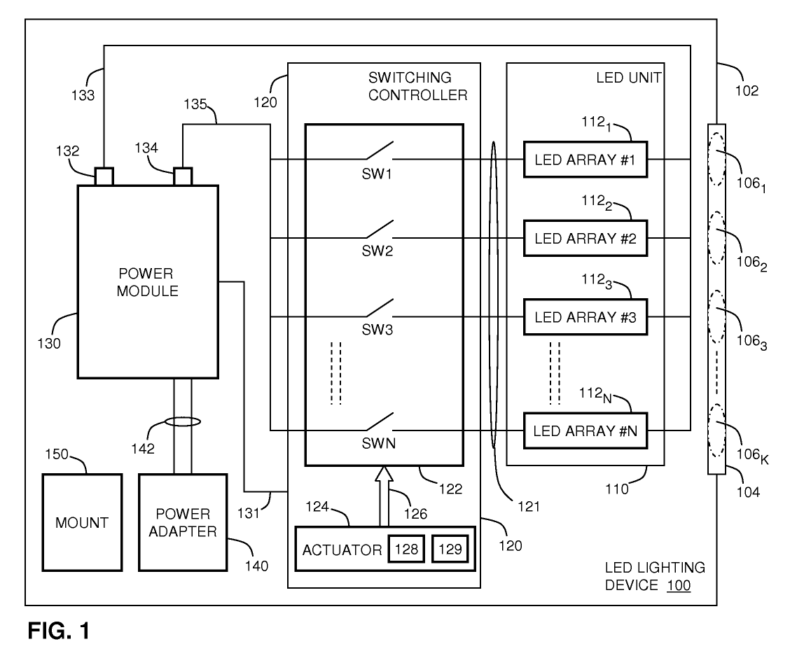

With reference now to the figures, and in particular with reference to FIG. 1, there is depicted a schematic diagram of an LED lighting device 100, according to one embodiment of the invention. The LED lighting device 100 generally includes an enclosure 102, an LED unit 110, a beam-forming optics 104, a switching controller 120, a power module 130, a power adapter 140, and a mount 150.

The power adapter 140 facilitates electrical coupling between an external power terminal (for example, industry-standard indoor/outdoor AC/DC socket, industry-standard or custom connector, and the like) and the power module 130. Correspondingly, the mount 150 provides mechanical coupling between the LED lighting device 100 and an external supporting structure thereof (e.g., stand, post, and the like).

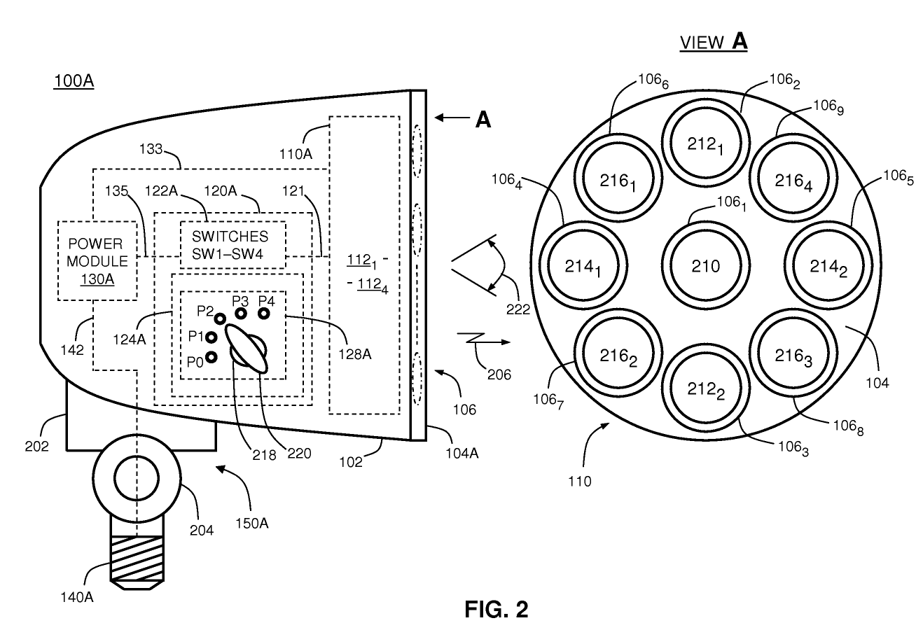

In alternate embodiments, the power adapter 140 may be a portion of the mount 150, as well as the latter may include elements adapted for affixing the enclosure 102 in particular orientation relative to the supporting structure or directing a light beam of the LED lighting device 100 (discussed below in reference to FIG. 2).

In the depicted embodiment, the power module 130 is generally an AC-to-DC converter coupled, via input wiring 142, to the power adapter 140 and having output terminals 132 and 134. However, in other embodiments, the power module 130 may be a transformer, an AC-to-AC converter, a DC-to-DC converter, or a combination thereof. In applications, power rating and output voltage of the power module 130 are chosen to be sufficient for energizing the LED unit 110 and the switching controller 120. In yet alternate embodiments, the power module 130 may be a portion of an external power apparatus, which is adapted for supplying electric power energizing the LED unit 110 of the LED lighting device 100. In these embodiments, the power module 130 is effectively reduced to the output terminals 132 and 134, with may be associated with the power adapter 140 or input wiring 142.

The LED unit 110 includes a plurality of N LED arrays 112. Each LED array 112 includes M component LEDs, where M≧1. In the LED arrays 112, the component LEDs thereof are electrically connected in a manner providing that all LED arrays 112 have two terminals of opposing polarity and the same operating voltage (e.g., from about 9 volts to about 30 volts AC or DC, etc.). For example, the component LEDs may individually be connected in parallel (when M is either an odd or even integer) or form one or more series networks that are connected in parallel (when M is an even integer).

The switching controller 120 generally includes a switching circuit 122, an actuator 124, and interface 126 coupling the actuator 124 to the switching circuit 122. Power for normal operation of the switching circuit 122 and the actuator 124 is illustratively provided to the switching controller 120 from the power module 130 via interface 131.

In one embodiment, the switching circuit 122 comprises N ON/OFF switches SW (switches SW1-SWN are shown), each switch SW controlling one LED array 112. Conventionally, the ON (i.e., CLOSED) state of a switch SW is a conducting state and the OFF (i.e., OPEN) state is a non-conducting state of the switch, respectively (illustratively, switches SW1-SWN are shown in the OFF states). Alternatively, or additionally, at least some switches SW may be portions of integrated switching assemblies or devices.

The switches SW are typically electrically or electronically operable solid-state switches (e.g., transistor-based switches, opto-electronic switches, and the like), electro-mechanical switches (e.g., relays), or other types of controlled switches, and the switching circuit 122 may include the switches of the same or different types.

In operation, ON/OFF states of the switches SW1-SWN are selectively controlled by the actuator 124 via the interface 126, for example, electrical, electro-mechanical, or mechanical interface. Preferably, the ON/OFF states of the switches SW1-SWN are controlled using signals having the same nominal voltage (e.g., from about 9 volts to about 30 volts AC or DC).

The actuator 124 is a user-controlled selector that has at least N+1 fixed position P0-PN, where N is equal to a number of the LED arrays 112 in the LED lighting device 100. The actuator 124 generally includes: (i) a logic (not shown) adapted for determining the ON/OFF states of the switches SW1-SWN, and (ii) an electro-mechanical control element 128 or an electronic control element 129, such as receiver of commands transmitted by a means of radio-frequency (RF), microwave, or optical (e.g., infra-red (IR)) signals, or both control elements 128 and 129.

In some embodiments, the actuator 124 is adapted for being manually operated, or engaged, by a user of the device 100. In particular, the actuator 124 may be engaged by the user using a rotational or linear movement of the electro-mechanical control element 128.

The control element 128 may comprise at least one multi-position switch (e.g., multi-position rotary or push-button switch), at least one multi-section switch (e.g., plurality of toggle or push-button switches or integrated multi-section toggle or push-button switching device, and the like), a plurality of individual switches, a numerical pad, a dial, or a combination thereof, and the like means known to those skilled in the art.

The user-selectable fixed positions P0-PN of the control element 128 include a first position corresponding to the OFF states of the switches SW1-SWN and a plurality of positions each selectively corresponding to an ON state of at least one of these switches. In one preferred embodiment, the fixed positions P0-PN correspond to the following states of the switches SW1-SWN: (i) the position P0, all switches SW are OFF, and (ii) the positions PQ, switches SW1-SWQ are ON and switches SW(Q+1)-SWN are OFF, where Q is an integer.

For example, (a) in the position P1, the switch SW1 is ON and the switches SW2-SWN are OFF, (b) in the position P2, the switches SW1 and SW2 are ON and the switches SW3-SWN are OFF, and (c) in the position PN, all switches SW1-SWN are ON.

A first terminal of each of the switches SW1-SWN is connected, using a conductor (or trace) 135, to one of the output terminals of the power module 130 (arbitrarily, as shown in FIG. 1, to the output terminal 134). Correspondingly, a second terminal of each of the switches SW1-SWN is selectively connected, using interface 121, to a first terminal of the respective LED arrays 112.

Second terminals of the LED arrays 112 are connected together and, using a conductor (or trace) 133, coupled to the other output terminal of the power module 130 (i.e., to the output terminal 132, as shown in FIG. 1). Polarity of the first and second terminals of the LED arrays 112 is selected such that closure of the switches SW1-SWN results in energizing of component LEDs of the LED arrays 112 coupled to the respective switches.

In operation, when any of the switches SW1-SWN is ON, component LEDs of the LED array 112 coupled to that switch emit light. By enabling the control element 128 (i.e., by setting the control element 128 to one of the fixed positions P0-PN), a user of the LED lighting device 100 may energize the pre-selected LED arrays 112 and, as such, control light intensity, as well as a power rating, of the device 100.

In alternate embodiments, the actuator 124 is remotely operated using RF, microwave, or optical signals transmitted to the LED lighting device 100 through open space (i.e., wirelessly) or via power lines connected to the power adapter 140. Such signals may be transmitted using, for example, X10, Z-Wave, Universal Powerline Bus (UPB), or IR technologies. In these embodiments, the actuator 124 comprises the electronic control element (or receiver) 129, which converts the transmitted information in commands for enabling/disabling particular groups of the LED arrays 112, as discussed above in reference to the actuator 124 provided with the electro-mechanical control element 128 having the multi-position switch(s).

In further embodiments, using a combination of the control element 128 and the receiver 129, the actuator 124 may be controlled manually and/or remotely.

Using the beam-forming optics 104, light emitted by the energized LEDs is collimated and/or focused to form a beam having pre-determined spatial or spectral properties. The beam-forming optics 104 typically comprises K individual lenses 106 (shown in phantom), which individually or collectively collimate and/or focus light of the component LEDs of the LED lighting device 100.

In one embodiment, the lenses 106 form a light beam 206 propagating within a pre-selected solid angle 222 (both shown in FIG. 2) such as, for example, about 12° (narrow angle beam spread) or multiples thereof, i.e., about 24° (medium angle beam spread), 36° (wide angle beam spread) or 60° (extra wide angle beam spread). The lenses 106 or beam-forming optics 104 may be interchangeable (i.e., adapted for being removed, replaced, or exchanged by a user), thereby providing a user-controlled means of selecting a pre-determined beam spread to achieve a desired lighting effect. Alternatively, or additionally, the beam-forming optics 104 may comprise optical filters of the light produced by the LED lighting device 100 or particular component LEDs thereof.

In one preferred embodiment, light intensity of the LED lighting device 100 increases when a handle of the multi-position switch of the control element 128 is moved from a position having a lower nominator to a position having a higher nominator (illustratively, from the position P1 to one of the positions P2-P4, or from the position P2 to one of the positions P3-P4, etc.). Similarly, the light intensity of the LED lighting device 100 decreases when the control element 128 is moved from a position having a higher nominator (e.g., position P4) to a position having a lower nominator (e.g., one of the positions P1-P3).

FIG. 2 depicts a schematic drawing illustrating an exemplary LED device 100A, according to one embodiment of the invention. For best understanding of the invention, the reader should refer to FIGS. 1-2 simultaneously.

In the LED lighting device 100A, the power adapter 140A is a portion of the mount 150A. In the depicted embodiment, the power adapter 140A illustratively comprises a threaded electrical coupling to an industry standard indoor/outdoor electrical socket (e.g., 110 VAC electrical socket) and mechanically affixes the LED device 100A to such a socket.

Alternatively, the LED lighting device 104A may be coupled to an industry-conventional step-down electric transformer (e.g., 120V to 12V-30V AC) using wiring techniques known to those skilled in the art, thereby providing low voltage electrical power to the lighting device 104A.

The mount 150A generally includes a support 202 and a joint 204. The joint 204 is adapted for tilting the enclosure 102 and, as such, directing a light beam 206 of the LED lighting device 100A. The solid angle beam spread 222 of the light beam 206 is determined by optical properties of lenses 106₁-106₉ of the interchangeable beam-forming optics 104A.

In FIG. 2, the LED lighting device 100A comprises 9 LEDs forming four LED arrays 112₁-112₄ comprised of, respectively: one (1) LED 210 comprising LED array 112₁; two (2) LEDs 212 (LEDs 212₁ and 212₂) comprising LED array 112₂; two (2) LEDs 214 (LEDs 214₁ and 214₂) comprising LED array 112₃; and four (4) LEDs 216 (LEDs 216₁-216₄) comprising LED array 112₄. In the depicted embodiment, component LEDs of the arrays 112₂-112₄ are illustratively disposed around the array 112₁ in a substantially circular pattern (shown in FIG. 2, View A).

In the depicted embodiment of FIG. 2, in the LED arrays 112 having more than one LED (i.e., LED arrays 112₂-112₄), the component LEDs are connected in parallel. Therefore, the LED arrays 112 of the LED lighting device 100A have the same operating voltage, which is substantially equal to an operating voltage of a component LED.

Referring further to FIG. 2, in one exemplary embodiment, the power module 130A is an AC-to-DC converter, the switching controller 120A is fabricated as a printed circuit board (PCB) comprising the switching circuit 122A and the actuator 124A having a control element 128A comprising a 5-position rotary switch 218 operable using a user-accessible handle 220. In one exemplary embodiment, the switches SW1-SW4 are transistor-based ON/OFF switches, and the first terminals of the switches SW1-SW4 are connected, using the trace 135, to a positive output terminal of the power module 130A.

The switch 218 has 5 fixed positions P0-P4 (illustratively, the handle 220 is shown in the position P2). In one embodiment, (i) in the position P0, the switches SW1-SW4 are OFF, (ii) in the position P1, the switch SW1 is ON and the switches SW2-SW4 are OFF, (iii) in the position P2, the switches SW1 and SW2 are ON and the switches SW3-SW4 are OFF, (iv) in the position P3, the switches SW1-SW3 are ON and the switch SW4 is OFF, and (v) in the position P4, the switches SW1-SW4 are ON.

In operation, when the handle 220 is placed in the position P0, the LED arrays 112₁-112₄ are not energized (i.e., turned OFF). Correspondingly, when the handle 220 is placed in the positions P1, P2, P3 or P4, the LED arrays 112₁, 112₁-112₂, 112₁-112₃, or 112₁-112₄ are energized (i.e., turned ON), respectively.

Using the handle 220, a user can manually control light intensity of the LED lighting device 100A. Simultaneously, by setting the handle 220 to various positions P0-P4 and, as such, energizing in each position a pre-determined array of the LED arrays 112, the user may also control a power rating of the LED lighting device 100A. Additionally, to modify spatial or spectral properties of the light beam 206, the user may replace the beam-forming optics 104A or individual lenses 106 thereof.

In one particular application, a plurality of the LED lighting devices 100 is used in a system of low-voltage landscape illumination where a user may manually control intensity of light provided by each LED lighting device. The LED lighting devices are powered using an external (i.e., remote) power apparatus, for example, an industry-conventional step-down transformer (e.g., household 120V or 220V to 12V-30V AC) of residential or on-site AC source, which may be coupled to one or more LED lighting devices by way of an electric cable or electric wiring using techniques known to those skilled in the art. In alternate embodiments, a step-down transformer and/or an AC-to-DC converter may be a portion of the LED lighting device. In alternate embodiments, light intensity (luminosity) of the device may be controlled by using remote features and functions previously described herein.

Although the invention herein has been described with reference to particular illustrative embodiments thereof, it is to be understood that these embodiments are merely illustrative of the principles and applications of the invention. Therefore, numerous modifications may be made to the illustrative embodiments and other arrangements may be devised without departing from the spirit and scope of the invention, which is defined by the appended claims.

What is claimed is:

1. A lighting device, comprising:
a plurality of arrays of LEDs, each array having at least one LED;
a power module adapted for energizing the arrays; and
a switching controller configured for selectively coupling/decoupling the arrays to/from the power module.

2. The lighting device of claim 1, wherein the switching controller comprises:
a plurality of switches, each switch selectively coupling/decoupling a pre-selected array of said arrays to/from the power module; and
an actuator configured for selectively controlling ON/OFF states of the switches.

3. The lighting device of claim 2, wherein the actuator comprises a control element adapted for engaging the actuator in pre-determined fixed positions.

4. The lighting device of claim 3, wherein said fixed positions include (i) a first fixed position corresponding to the OFF states of the switches, and (ii) a plurality of fixed positions each selectively corresponding to an ON state of at least one of the switches.

5. The lighting device of claim 3, wherein the actuator is manually engaged in the fixed positions using rotational or linear movements of the control element.

6. The lighting device of claim 5, wherein the control element comprises switching devices selected from the group consisting of switches, multi-position/multi-section switches, numerical pads, dials, and a combination thereof.

7. The lighting device of claim 3, wherein the control element comprises a receiver of radio-frequency, microwave, or optical signals transmitted using X10, Z-Wave, Universal Powerline Bus, infra-red technologies or RF transmitter technologies.

8. The lighting device of claim 2, wherein the switches are electrically or electronically operable solid-state switches or electro-mechanical switches.

9. The lighting device of claim 2, wherein the actuator comprises a switching device configured for selectively controlling the ON/OFF states of the switches.

10. The lighting device of claim 9, wherein the switching device includes a plurality of individual switches, at least one multi-position switch, at least one multi-section switch, or a combination thereof.

11. The lighting device of claim 1, wherein the power module comprises a transformer, an AC-to-DC converter, or a combination thereof.

12. A plurality of the lighting devices of claim 1 powered using a remote step-down transformer.

13. The lighting device of claim 1, further comprising a beam-forming optics adapted for forming a light beam having pre-determined spatial or spectral properties.

14. The lighting device of claim 13, wherein the beam-forming optics or individual lenses thereof are interchangeable.

15. A lighting device, comprising:
arrays A1-A4 of LEDs, each array having at least one LED;
a power module adapted for energizing the arrays;
a switching controller including:
switches SW1-SW4 each configured for selectively coupling/decoupling one of the arrays to/from the power module; and
an actuator selectively controlling ON/OFF states of the switches;
an enclosure housing the arrays, the power module, the switching controller, and a beam-forming optics; and
a mount adapted for controlling spatial orientation of the enclosure and including a power adapter for coupling to a source of electric power.

16. The lighting device of claim 15, wherein the power module comprises a transformer, an AC-to-DC converter, or a combination thereof.

17. The lighting device of claim 15, wherein the power adapter is configured for electrical and mechanical coupling to an outdoor/indoor power terminal.

18. The lighting device of claim 15, wherein the actuator is adapted for engagement in 5 fixed positions and setting the switches SW1-SW4 as follows:
in the first position: switches SW1-SW4 are OFF;
in the second position: the switch SW1 is ON, and the switches SW2-SW4 are OFF;
in the third position: the switches SW1-SW2 are ON, and the switches SW3-SW4 are OFF;
in the fourth position: the switches SW1-SW3 are ON, and the switch SW4 is OFF; and
in the fifth position: the switches SW1-SW4 are ON.

19. The lighting device of claim 15, wherein the LEDs of the arrays A2-A4 are disposed around the array A1 in a substantially circular pattern.

20. The lighting device of claim 15, wherein the array A1 comprises 1 LED, the array A2 comprises 2 LEDs, the array A3 comprises 2 LEDs, and the array A4 comprises 4 LEDs.

21. The lighting device of claim 15, wherein the beam-forming optics comprises a plurality of lenses forming, selectively or collectively, light beams propagating within pre-determined solid angles.

22. The lighting device of claim 21, wherein the beam-forming optics or the individual lenses thereof are interchangeable.

23. A plurality of the lighting devices of claim 15 powered using a remote step-down transformer.

24. A method of operating a lighting device having a plurality of LEDs, the method comprising:
organizing the LEDs in arrays, each array including at least one LED; and
selectively coupling/decoupling the arrays to/from a power source configured for energizing the LEDs by using switches controlled via a user-operated actuator.

25. The method of claim 24, further comprising:
adapting the actuator for selective engagement in pre-determined fixed positions, said positions including (i) a first position corresponding to the OFF states of the switches, and (ii) a plurality of positions each selectively corresponding to an ON state of at least one of the switches.

26. The method of claim 24, further comprising:
focusing or collimating light emitted by the LEDs to form light beams having pre-determined spatial or spectral properties.

27. The method of claim 26, further comprising:
focusing or collimating the light using interchangeable beam-forming optics.

28. The method of claim 24, further comprising:
powering a plurality of the lighting devices using a remote step-down transformer.
